(19) United States
(12) Patent Application Publication
(10) Pub. No.: US 2015/0127569 A1
(43) Pub. Date: May 7, 2015

(54) MOBILE EMPLOYMENT DISCOVERY USING GEOGRAPHIC LOCATION MATCHING

(71) Applicant: Clearfit Inc., Toronto (CA)

(72) Inventors: Ben Baldwin, Toronto (CA); Jamie Schneiderman, Toronto (CA)

(21) Appl. No.: 14/534,541

(22) Filed: Nov. 6, 2014

Related U.S. Application Data
(60) Provisional application No. 61/900,607, filed on Nov. 6, 2013.

(51) Int. Cl. G06Q 10/10; H04W 4/02

(52) U.S. Cl. CPC G06Q 10/1053; H04W 4/02
USPC 705/321

(57) ABSTRACT

A computer implemented employment discovery system for identifying a potential employment position of an employer for an employment candidate, the system comprising: a computer processor configured for executing of a set of instructions stored in a memory for: storing candidate employment profile information and a candidate contact address of a candidate mobile device associated with the employment candidate; storing agent profile information for a candidate agent associated with the employment candidate including an agent contact address of an agent mobile device associated with the candidate agent; generating employment position information of the potential employment position including geographical information of the employer; receiving a geographical location of the agent mobile device and generating a geographical match of the geographical location with the geographical information by comparing the geographical location with the geographical information; generating a profile match of the candidate employment profile information with the employment position information by comparing the candidate employment profile information with the employment position information; based on the geographical match and the profile match, generating a match message including details of the potential employment position and the geographical information of the employer; and sending the match message to the agent contact address over a communications network to the agent mobile device.

### CROSS REFERENCE TO RELATED APPLICATIONS

This application is a non provisional application of U.S. Patent Application No. 61/900,607 filed Nov. 6, 2013, the contents of which are incorporated herein by reference.

### FIELD

The present invention relates to systems and methods for location-based matching between prospective employers and suitable job candidates.

### BACKGROUND

The current job search process includes both social and location based aspects. It is known that most people prefer to find employment that is located closer to where they live or are otherwise predominately located in a geographical area (e.g. close day care, school of children, spouses location, friend's neighborhood, etc.). Further, it is known that most people find jobs and/or promising job leads though leveraging their social network (e.g. through family, friends, former business colleagues, etc.), however individuals in a person's social network are not dedicated to finding suitable employment positions for prospective job candidates. Therefore, it can be very difficult, from both an employer's and job candidate's perspective, to identify and fill an employment position with an appropriate employer-employee match.

Traditionally, job candidates peruse job ads, send resumes to employers, cold call employers, or even visit employer offices or stores in person to inquire whether the employer has any open employment positions. This traditional job seeking approach can have numerous disadvantages including, for example, limited effectiveness, lack of personal communication or contact between employers job candidates job candidates not knowing whether the employer has a need for people with their backgrounds and experience, employers receiving inquiries from job candidates who are not qualified or who are not a good match for the employer, and job candidates often required to wait until they hear back from an employer. This traditional process can be frustrating and waste of valuable time and resources, both from the employer and job candidate perspectives. These disadvantages can be even more problematic when employers have an immediate need for a new employee, since the traditional process can take a long time before qualified job candidates learn about these employment opportunities, employers interview job candidates who are good matches, and job candidates are actually hired.

On-line employment search resources, such as monster.com, have enhanced the way in which employers and job candidates publicize their employment needs and perform employment position searches. When using monster.com, for example, employers can post descriptions of their open employment positions, which can then be searched by job candidates who access the website. If a job candidate is interested in a posted employment position, the job candidates can contact a person identified in the description or apply on-line by completing a form provided by the employer. Thus, these types of websites are still based on the traditional process summarized above, but with the convenience that employers can post employment position openings on-line, and job candidates can review on-line available employment position and submit a resume or other application materials using their computer.

While websites such as monster.com have provided an improved level of convenience to employers and job candidates relative to other traditional methods, known employment resources nevertheless suffer from a number of disadvantages and inconveniences associated with the time consuming process of soliciting resumes or posting on-line listings, reviewing resumes mailed or submitted by job candidates, deciding which job candidates are good matches after reviewing resumes, contacting those job candidates, scheduling interviews (assuming the job candidates is still available and interested in the position since the job candidates may have accepted another position), conducting the interview, and going through the hiring process. In-demand employers can be inundated with candidate volume with no regard for candidate fit for the job or company culture, which is a factor with a successful hire. Further, this traditional process has limited employer-candidate interaction, on-line submissions can be impersonal, and employers and job candidates may not meet in person, or if they do, meetings may not occur until well after a job candidate expresses interest in an available employment position.

A further disadvantage with traditional employment seeking methods is that the ability for job candidates to interact dynamically and spontaneously with potential employers is limited, due to the requirement of an employer first having to post an employment position and then the job candidate identify and then apply or the employment position. Unlike an applicant applying in-person, an employer cannot see how a candidate “carries themselves” which why the vast majority of employers and recruiters require an in-person meeting before hiring a candidate. Further, the current ability for a job candidate to find a suitable employment position in their preferred geographical location is difficult, as one must rely on at best keyword searching to filter employment position postings. A further disadvantage with traditional employment seeking methods is that the ability for individuals in the employment candidate's social network to come across suitable employment positions is limited, other than for the individual themselves to search and comb through employment position postings, a considered manually intensive and time consuming process.

### SUMMARY

It is an object of the present invention to provide a location-based employment position matching computer implemented system and associated method for connecting prospective employers and with an employment profile of a job candidate.

Disadvantages with traditional employment seeking systems is that the ability for job candidates to interact dynamically and spontaneously with potential employers is limited, due to the requirement of an employer first having to post an employment position and then the job candidate identify and then apply or the employment position. Further, the current ability for a job candidate to find a suitable employment position in their preferred geographical location is difficult, as one must rely on at best keyword searching (e.g. manual and/or search engine assisted) to filter employment position postings. A further disadvantage with traditional employment seeking methods is that the ability for individuals in the employment candidate's social network to come across suitable employment positions during the individual's day-to-day activities is limited, other than for the individual themselves to search and comb through employment position postings, a considered manually intensive and time consuming process. Another disadvantage is that there is no regard to fit when considering in-person job applications.

Contrary to current employment seeking systems there is provided an employment position matching system and method directed to computer-implemented, location-based methods for matching and connecting an employer (represented by a published or otherwise defined employment position registered with an employment service) and a candidate employee (or optionally their agent) through the use of a mobile communication device for the candidate employee and/or agent and a defined geographical location of the prospective employment position of the employment position or a device held by that employer as opposed to just their inputted geo-location. The candidate-position matching is conducting using real-time and predefined data including real-time geographical location of the mobile device, the geographical location of the employment position or hiring manager, a predefined employment profile of the employment position having a plurality of employment position parameters, and a predefined candidate profile having a plurality of candidate parameters. Using the real-time and/or predefined data, a match representing a suitable employment candidate for the employment position is determined (e.g. by an employment service). For example, it is recognised that the employment candidate can be determined as being in the geographical vicinity of the employer, however the employment candidate can be considered an inappropriate match for employer as the predefined candidate profile does not correspond (e.g. match) a predetermined number of threshold parameters of the predefined employment profile.

Contrary to current employment seeking systems there is provided an employment position matching system and method directed to computer-implemented, location-based methods for matching and connecting an employer (represented by a published employment position) and a candidate employee (or their agent) through the use of a mobile communication device for the candidate employee (and/or agent) and a defined geographical location of the prospective employer (e.g. an individual representing the employment position, for example a hiring manager of the employer, a store manager of the employer, etc.). The candidate-position matching is conducted using real-time and predefined data including real-time geographical location of the mobile device, the geographical location representing the employer (e.g. individual acting as the employer representative), a predefined employment profile of the employment position having a plurality of employment position parameters, and a predefined candidate profile having a plurality of candidate parameters. Using the real-time and/or predefined data, a match representing a suitable employment candidate for the employment position is determined (e.g. by an employment service).

Candidates can have multiple agents and agents can have multiple candidates. Agents also do not need to have created an employment profile themselves—they are just acting on a candidate's behalf (candidates have employment profiles).

Other embodiments of the computer implemented matching system are directed to employment candidate identification for potential employers and inviting the employer (e.g. by selecting a link provided in a targeted electronic message sent to the employer device either directly by the mobile device or via an employment service server in communication with the mobile device) to find out more about a selected employment candidate that has, and optionally other employment candidates that have, been identified via their mobile devices as being in a geographical vicinity of the employer and/or employment positions of the employer as well as being suitable for a defined employment position of the employer. The employer and employment candidate are provided with real-time location or distance data such as a distance between current locations of the employer and employment candidate (e.g. as determined by comparing geographic location data of the mobile device associated with an employment profile of the employment candidate and geographic location data of the employment position and/or the individual representing the employment position). For example, this comparison of geographic location data facilitates individuals associated with an employment position (e.g. hiring manager of the employer, store manager, etc.) and employment candidates to assess each other's geographic locations and to facilitate real-time in-person contact between the employment candidate (and/or agent representing the employment candidate) and the individual employer and/or employer representative, for those employer-candidate pairs having a threshold number of the employment position parameters identified as matching a portion (e.g. one or more) of the plurality of candidate parameters.

Further, for example, this comparison of geographic location data facilitates individuals associated with an employment position (e.g. hiring manager of the employer, store manager, etc.) to become aware of the plurality of suitable employment candidates frequenting the geographic location of the employer, such information as tracked and provided by the employment service to the employer as further described below. As such, the employment service provides candidate information to the employer based on matching of candidate profiles that are discovered to be in a predefined geographic vicinity of the employer. As such, the described embodiments facilitate the employer in assessing whether an employment location would be suitable for the employment candidate given where the candidate and/or those associated with the employment candidate (e.g. employment agent) frequent or otherwise travel during their daily routine. Thus, the embodiments can provide for more effective, timely and efficient matching of employers with employment candidates, with the added convenience that all of this can be done using their mobile devices at any time. One benefit of the embodiments is that it is in the best interest of the employment candidate (and/or the employment agent acting on behalf of the employment candidate) to be informed of employment position opportunities as the individual travels about a given geographical area in which employers with predefined employment position profiles are located.

One embodiment involves displaying, on a mobile communication device of an individual associated with the candidate profile (e.g. employment candidate, candidate agent, etc.) data of a employment position (matching qualifications, experience, etc. of data parameters of the candidate profile) for an employment position opportunity offered by the employer in a predefined geographical vicinity (e.g. discovered in a defined metre radius of the mobile device, discovered when the mobile device is in front of a building of the employer, discovered when the mobile device is considered adjacent to a representative individual of the employer, discovered when the mobile device is within a predefined distance from the employer, etc.), together with employer location data such as a distance between a current location of the mobile device and a current location of the employer.

The method can further comprise receiving a first input entered by the individual (e.g. employment candidate, candidate agent, etc.) into the mobile device and sending an electronic message having candidate data to the employment service server (via a communications network) or to the hiring manager's device/personal email address as confirmation that the individual acknowledges (e.g. accepts the employment position as potentially appropriate for the employment candidate—for example the employment candidate is interested in pursuing the displayed employment opportunity) the displayed employment opportunity. For example, in the case of the individual being the candidate agent, the electronic message is sent from the candidate agent's mobile device to a computer device (e.g. mobile device) of the employment candidate (e.g. via the employment service server) based at least in part upon the first input. The electronic message can contain the candidate data as candidate generated image/video data representing employment related qualities of the candidate. For example, the image/video data can be previously generated and stored on the mobile device, can be dynamically generated by the candidate using image/video processing capabilities of the mobile device when the candidate is formulating the electronic message, and/or can be stored and retrieved from the employment service server for including in the electronic message. It is recognised that a copy of the image/video data of the candidate can be contained within electronic message and/or the electronic message can contain an electronic link to access the imageNideo data stored remotely on the mobile device and/or via the employment service server.

A first aspect provided is a computer implemented employment discovery system for identifying a potential employment position of an employer for an employment candidate, the system comprising: a computer processor configured for executing of a set of instructions stored in a memory for: storing candidate employment profile information and a candidate contact address of a candidate mobile device associated with the employment candidate; storing agent profile information for a candidate agent associated with the employment candidate including an agent contact address of an agent mobile device associated with the candidate agent; generating employment position information of the potential employment position including geographical information of the employer; receiving a geographical location of the agent mobile device and generating a geographical match of the geographical location with the geographical information by comparing the geographical location with the geographical information; generating a profile match of the candidate employment profile information with the employment position information by comparing the candidate employment profile information with the employment position information; based on the geographical match and the profile match, generating a match message including details of the potential employment position and the geographical information of the employer; and sending the match message to the agent contact address over a communications network to the agent mobile device.

A second aspect provided is a computer implemented employment discovery system for identifying a potential employment position of an employer for an employment candidate, the system comprising: a computer processor configured for executing of a set of instructions stored in a memory for: storing candidate employment profile information of a candidate employment profile and a contact address of a mobile device associated with the candidate employment profile; generating employment position information of the potential employment position including geographical information of the employer; receiving a geographical location of the mobile device and generating a geographical match of the geographical location with the geographical information by comparing the geographical location with the geographical information; generating a profile match of the candidate employment profile information with the employment position information by comparing the candidate employment profile information with the employment position information; based on the geographical match and the profile match, generating a match message including details of the potential employment position and the geographical information of the employer; and sending the match message to the contact address over a communications network to the mobile device.

For example, the mobile device can be that of the employment candidate or that of the candidate agent.

### BRIEF DESCRIPTION OF THE DRAWINGS

Exemplary embodiments of the invention will now be described in conjunction with the following drawings, by way of example only, in which:

FIG. 1 is a block diagram of a employment discovery system;

FIG. 2 is a block diagram showing an example configuration of a device of FIG. 1;

FIG. 3 is a block diagram showing an example configuration of a server device of FIG. 1.

### DESCRIPTION

The claimed invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the claimed invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the claimed invention is provided below along with accompanying figures that illustrate the principles of the invention. The claimed invention is described in connection with such embodiments, but the claimed invention is not limited to any embodiment. The scope of the claimed invention is limited only by the claims and the claimed invention encompasses numerous alternatives, modifications and equivalents. Numerous specific details are set forth in the following description in order to provide a thorough understanding of the claimed invention. These details are provided for the purpose of example and the invention may be practiced according to the claims without some or all of these specific details. For the purpose of clarity, technical material that is known in the technical fields related to the claimed invention has not been described in detail so that the claimed invention is not unnecessarily obscured.

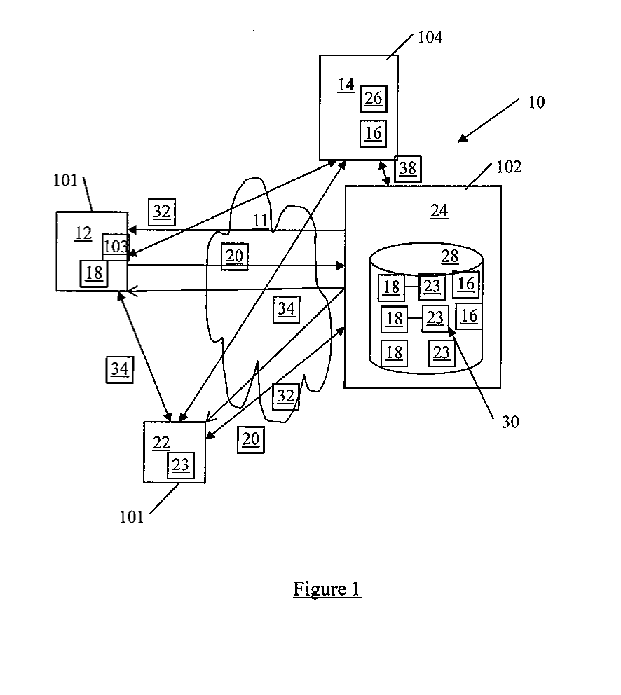

Referring to FIG. 1, the computer implemented employment discovery system 10 provides an advantage for employment candidates 12 to interact dynamically and spontaneously with potential employers 14, due to the systematic matching of a predefined employment position 16 with a candidate profile 18 by taking into account real-time geographic vicinity information 20. This system 10 provides an advantage of reducing the need for the employment candidate 12 to find a suitable employment position in their preferred geographical location by relying on keyword searching (e.g. manual and/or search engine assisted) to filter published employment position postings. A further advantage of the system 10 is providing the ability for individuals in the employment candidate's social network (e.g. one or more candidate agents 22) to come across suitable employment positions during the individual's day-to-day activities, rather than necessitating the individual themselves search and comb through published employment position postings, a considered manually intensive and time consuming process. As further discussed below, the candidate agents 22 each have an agent profile 23 having one or more agent profile parameters registered with the employment service 24 (on server 102).

It is recognised that the agent's profile 23 can contain image data (e.g. still images, video such as video clips, etc.) providing image information (e.g. portraits of the candidate, video descriptions of the candidate 12, etc.) that can be related to candidate 12 details of otherwise as supplementary information of the candidate 12 that is in image format rather than as in textual format (e.g. traditional resume written content). This candidate 12 image data can be candidate generated image/video data representing employment related qualities of the candidate 12. For example, the image/video data can be previously generated and stored on a mobile device 101, can be dynamically generated by the candidate 12 using image/video processing capabilities of the mobile device 101 when the candidate 12 is formulating the electronic message (e.g. upon request by the agent 22 in communication with the candidate 12 over the communications network—e.g. device 101 to device 101 communication), and/or can be stored and retrieved from the employment service 24 (via server 102) for including in the electronic message. It is recognised that a copy of the image/video data of the candidate 12 can be contained within electronic message and/or the electronic message can contain an electronic link to access the image/video data stored remotely on the mobile device 101 and/or via the employment service 24 (via server 102).

Further, it is recognised that the candidate's profile 18 can contain image data (e.g. still images, video such as video clips, etc.) providing image information (e.g. portraits of the candidate 12, video descriptions of the candidate 12, etc.) that can be related to candidate details of otherwise as supplementary information of the candidate 12 that is in image format rather than as in textual format (e.g. traditional resume written content). This candidate 12 image data can be candidate generated image/video data representing employment related qualities of the candidate 12. For example, the image/video data can be previously generated and stored on a mobile device 101, can be dynamically generated by the candidate 12 using image/video processing capabilities of the mobile device 101 when the candidate 12 is formulating the electronic message (e.g. upon request by the agent 22 in communication with the candidate 12 over the communications network—e.g. device 101 to device 101 communication), and/or can be stored and retrieved from the employment service 24 (via server 102) for including in the electronic message. It is recognised that a copy of the image/video data of the candidate 12 can be contained within electronic message and/or the electronic message can contain an electronic link to access the image/video data stored remotely on the mobile device 101 and/or via the employment service 24 (via server 102).

It is recognised that sending the match message to the agent contact address can be done over a communications network 11 to the agent mobile device 101 or directly to the candidate mobile device 101. Also vice-versa if it's the hiring manager 14 using an agent 22 to search candidates 12 around the agent 22. It is recognised that the employer's profile 16 can contain image data (e.g. still images, video such as video clips, etc.) providing image information (e.g. portraits of the employer 14, video descriptions of the employer physical environment and/or staff, etc.) that can be related to employer details of otherwise as supplementary information of the employer 14 that is in image format rather than as in textual format (e.g. traditional resume written content). For example, any of the employer's profile 16 (e.g. image and/or written content) can be associated with the predefined employment position 26.

Referring again to FIG. 1, employment position matching system 10 is directed to computer-implemented, location-based methods monitored or otherwise managed by the employment service 24 for matching and connecting an employer 14 (represented by a published or otherwise defined employment position 26 registered with the employment service 24) and a candidate employee 12 (or optionally their agent 22) through the use of a mobile communication device 101 for the candidate employee 12 and/or agent 22 and the defined geographical location 26 of the prospective employment position of the employer 14. The candidate position matching is conducted using real-time and predefined data including real-time geographical location 20 of the mobile device 101, the geographical location 26 of the employment position, a predefined employment profile 16 of the employment position having a plurality of employment position parameters, and a predefined candidate profile 18 having a plurality of candidate parameters. Using the real-time and/or predefined data by the employment service 24 (via server 102), a match representing a suitable employment candidate 12 for the employment position is determined (e.g. by the employment service 24). For example, it is recognised that the employment candidate 12 can be determined as in the geographical vicinity of the employer 14, however the employment candidate 12 can be considered an inappropriate match for the employer 14 as the predefined candidate profile 18 does not correspond (e.g. match) a predetermined number of threshold parameters of the predefined employment profile 16. As such, the profiles 16,18 are registered with the employment service 24, for example stored in a storage 28 of a server computer 102 implementing the employment service 24, as further described below.

It is also recognised that the candidate agent 22 has the agent profile 23 that is also registered with the employment service 24, for example stored in the storage 28 of the server computer 102 implementing the employment service 24, as further described below. Further, as shown in FIG. 1, each agent profile 23 is associated with one or more candidate profiles 18 as candidate-agent profile pairings 30. In this manner, when the employment service 24 receives geographic information 20 from the agent mobile device 101, the employment service 24 can associate the received geographic information 20 with that of the candidate profile 18 of the candidate-agent profile pairing 30. Knowing the geographic information 20 and the candidate profile 18, the employment service 24 can then try to match (i.e. discover) the data 18,20 with corresponding predefined employment profiles 16 in the storage 28 in combination with the geographic information 26 of the employer (i.e. geographic information 26 that is associated with the employment profile 16). It is recognised that the geographic information 26 can be provided dynamically and in real-time by the employer 14 to the employment service 24. It is also recognised that the geographic information 26 can be provided initially by the employer 14 to the employment service 24 and thus stored in the storage 28.

It is also recognised that the employment service 24 can send (e.g. push) content (via server 102) from the candidate profiles 18 (e.g. including image content) to the employers 14 (e.g. to the employer account registered with the employment service 24). For example, the content can include image content related to candidates 18 that have matched the predefined employment profiles 16 and geographic information 26 of the employer 14. In this manner, the employer 14 can be kept informed of the candidates 18 that have been in the geographical vicinity of the employer 14. For example, the content can include image content related to candidates 18 that have not matched the predefined employment profiles 16 but have matched the geographic information 26 of the employer 14.

It is also recognised that the employment service 24 can send (e.g. pull) content (via server 102) from the candidate profiles 18 (e.g. including image content) to the employers 14 (e.g. to the employer account registered with the employment service 24), based on the employer 14 responding to a match message containing a link to the content stored on the employment service 24 (via server 102). For example, the content can include image content related to candidates 18 that have matched the predefined employment profiles 16 and geographic information 26 of the employer 14. In this manner, the employer 14 can be kept informed of the candidates 18 that have been in the geographical vicinity of the employer 14. For example, the content can include image content related to candidates 18 that have not matched the predefined employment profiles 16 but have matched the geographic information 26 of the employer 14. As noted above, the image/video content can be prestored in storage associated with the employment service 24 (via server 102) or can be dynamically generated by the candidate 12 using their mobile device 101 and then forwarded to the employer 24 either directly by the candidate 12 via the device 101 over the communications network 11 or via the employment service 24 (via server 102) acting as an intermediate node on the communications network 11 between the device 101 and the computer system of the employer 14.

It is also recognised that the employment service 24 can send (e.g. pull) content from the candidate profiles 18 (e.g. including image content) to the employers 14 (e.g. to the employer account registered with the employment service 24), based on the employer 14 responding to the match message received by the employer 14. For example, the content can include image content related to candidates 18 that have matched the predefined employment profiles 16 and geographic information 26 of the employer 14. In this manner, the employer 14 can be kept informed of the candidates 18 that have been in the geographical vicinity of the employer 14. For example, the content can include image content related to candidates 18 that have not matched the predefined employment profiles 16 but have matched the geographic information 26 of the employer 14. As noted above, the image/video content can be prestored in storage associated with the employment service 24 (via server 102) or can be dynamically generated by the candidate 12 using their mobile device 101 and then forwarded to the employer 24 either directly by the candidate 12 via the device 101 over the communications network 11 or via the employment service 24 (via server 102) acting as an intermediate node on the communications network 11 between the device 101 and the computer system of the employer 14.

Referring again to FIG. 1, the computer implemented employment discovery system 10 for identifying the potential employment position of the employer 14 for the employment candidate 12 can be operated (via a computer processor configured for executing of a set of instructions stored in a memory as further discussed below) by the server computer 102 of the employment service 24 as follows. Steps involved can be: storing candidate employment profile 18 information and a candidate contact address of the candidate mobile device 101 associated with the employment candidate 12; storing agent profile information 23 for the candidate agent 22 associated via pairing 30 with the employment candidate profile 18 including an agent contact address of the agent mobile device 101 associated with the candidate agent 22; accessing employment position information 26 of the potential employment position including geographical information of the employer 14; receiving a geographical location 20 of the agent mobile device 101 and generating a geographical match of the geographical location 20 with the geographical information 26 by comparing the geographical location 20 with the geographical information 26 (e.g. determined within a predefined geographic vicinity); generating a profile match of the candidate employment profile 18 information with the employment position information 16 by comparing the candidate employment profile information 18 with the employment position information 16; based on the geographical match and the profile match, generating a match message 32 including details of the potential employment position and the geographical information of the employer 14; and sending the match message 32 to the agent contact address over a communications network 11 to the agent mobile device 101 for subsequent display or sending the message directly to the candidate, bypassing the agent. Accordingly, different processes can be provided, depending on the different levels of service that is offered by the employment service 24). It is recognised that the candidate agent 22 can then contact via message 34 the employment candidate 12 to inform them of the details of the employment position match outlined in the message 32 received from the employment service 24. The message 34 can be in the form of an email, a phone call, a text message, etc. It is recognised that the message 34 can be communicated directly between the mobile devices 101 of the employment candidate 12 and the candidate agent 22, in a communication path over the network 11 that bypasses the server 102. Alternatively, it is recognised that the message 34 can be communicated between the mobile devices 101 of the employment candidate 12 and the candidate agent 22, via the server 102. In either case, the server 102 can receive confirmation (e.g. via noting the contents of the message 34, via a separate confirmation message, etc.) of the candidate agent 22 and/or the employment candidate 12 acknowledging that the employment position match determined by the employment service 24 is suitable or otherwise acceptable. Alternatively, or in addition to, the server 102 can receive confirmation (e.g. via noting the contents of the message 34, via a separate confirmation message, etc.) of the candidate agent 22 and/or the employment candidate 12 acknowledging that the employment position match determined by the employment service 24 is unsuitable or otherwise unacceptable. Candidate may also reach out to employer or hiring managers device directly, via agent getting employers permission while face-to-face with employer.

Referring again to FIG. 1, another embodiment for the computer implemented employment discovery system 10 to identify the potential employment position of the employer 14 for the employment candidate 12 can be implemented as: storing candidate employment profile information of the candidate employment profile 18 and the contact address of the mobile device 101 associated with the candidate employment profile 18; accessing employment position information 26 of the potential employment position including geographical information of the employer 14; receiving the geographical location 20 of the mobile device 101 and generating the geographical match of the geographical location 20 with the geographical information 26 by comparing the geographical location 20 with the geographical information 26; generating a profile match of the candidate employment profile information with the employment position information by comparing the candidate employment profile 18 information with the employment profile 16 information; based on the geographical match and the profile match, generating a match message 34 including details of the potential employment position and the geographical information 26 of the employer; and sending the match message 34 to the contact address over the communications network 11 to the mobile device 101. For example, the mobile device 101 can be that of the employment candidate 12 or that of the candidate agent 22. Also, the hiring manager, using their mobile device, can proactively search candidates and agents around them for matches (it works in both directions).

Yet other embodiments are directed to managing predefined candidate profiles 18, predefined employment position profiles 16, performing comparisons between employers 14 and candidates 12 by identifying matches between profile parameters and between geographic location information 20,26, and providing employment opportunity results that match or satisfy certain threshold criteria (e.g. meet or exceed a profile parameter degree match, meet or exceed a geographic vicinity, etc.). For this purpose, employment candidates 12 can register their predefined employment profile 18 with the employment service 24 and download an employment application 103 to their mobile device 101 that is operable to communicate with the employment service server 102 to receive employment data therefrom. Further, employment candidates 12 can prepare their respective candidate profiles 18, e.g., experience, qualifications and residence zip code for candidates, and job title and desired qualifications or experience for employers 14. These profiles 18 are transmitted to the intermediate computer of the server 102 and stored in the database 28 as registered profiles with the employment service 24. When the employer requests search results for candidates 12 or expresses an interest in a particular candidate 12, or a candidate 12 requests employment opportunities or expresses an interest in a particular employer 24, these initial search communications are directed through the intermediate computer 102 until the employer 14 and/or candidate 18 are provided with each other's personal contact information so that they may contact each other directly (by phone, e-mail or text) without being directed through the intermediate computer 102.

For example, according to one embodiment, the intermediate computer 102 accesses one or more employer profiles 16 comprising respective employment opportunities associated with the geographic location 26 of respective employers 14. A candidate employee launches the application 103, registers profile information 18 (e.g., experience and qualifications), and sends the geographic information 20 as an electronic message to the intermediate computer 102. The intermediate computer 102, e.g., utilizing a profile or comparison engine (e.g. implemented on a computer processor), compares the received candidate employee profile 18 and criteria with the stored employer profiles 16 (e.g., for matching or substantially matching job titles, experience, etc.), selects one or more employer profiles 16 based at least in part upon the geographic 20,26 criteria and profile 16,18 comparison, and sends the electronic message 34 to the mobile device 101 with the selected employer profile 18 with the employer's 14 employment opportunity. After the candidate 12 has reviewed the job details, the intermediate computer 102 can optionally receive a further electronic message from the candidate's mobile device 101 indicating whether the candidate employee 12 wants to meet (e.g., now, later, never or not interested) with the selected employer 14 regarding the employment opportunity offered by the selected employer 12 or otherwise deems that the discovered job opportunity reflected by the employment profile 16 is suitable for the employment candidate 12 (as decided by the employment candidate 12).

The message 34 can also contain employer related requests or questions for the candidate 12 to respond to. For example, the candidate 12 can use these requests/questions of the employer 14 in the message 34 to select suitable prestored image/video content or otherwise dynamically generate suitable image/video content using the image processing (and sound processing) functionality (e.g. camera, microphone, etc.) of the mobile device 101. Accordingly, the image/video content selected or generated by the candidate can then be made available to the employer 14 via messaging over the communication network 11 either directly between devices 101,104 or using the device 102 as an intermediate node between the devices 101,104 over the communications network.

The employment discovery system 24 can be configured to receive a registration request from the employer including an employment position profile. In addition to employer registration request, candidate can complete the profile on their own, because they want to search jobs around them—it does not need to be initiated by the employer's registration request. Further, the employment discovery system 24 can receive a status request from the agent mobile device; and sending details of the status information over the communications network to the agent mobile device or directly to the candidate or hiring manager.

The employment discovery system 24 can also be configured to store employer position information 26 for those employers not yet registered with the employment discovery system 24. As such, the employment discovery system 24 would contain a pre-registration employment position profile 16 for the employer 14 defining “general” employment requirements and qualities of the employer 14 (e.g. any employer identified as a restaurant would have general requirements for servers, busboys, kitchen staff, managers, etc., similarly any employer identified as a retail store would have general requirements for managers, salespeople, cashiers, etc.). In addition to employers 14, registered or not, the candidate 12 can complete the profile 18 on their own, because they want to search jobs around them—it does not need to be initiated by the employer. Further, the employment discovery system 24 can receive a status request from the agent mobile device 101; and send details of the status information over the communications network 11 to the agent mobile device 101 or directly to the candidate device 101 or hiring manager device 104.

The intermediate computer 102 and/or the mobile device 101 can send an electronic message 38 to the computer device 104 of the discovered employer 14 providing the employer 14 with access to the candidate employee's profile 18 details (e.g. if the candidate 12 is interested). For example, the message 38 can include a link to the employment candidate profile 18 stored in the storage 28.

Other embodiments are directed to computer program products or mobile applications comprising a non-transitory, computer readable storage medium having a sequence of instructions which, when executed by the device 102, cause the one or more processors of the device 102 to execute a process for location-based profile-to-profile matching of the employer 14 with the candidate employee 12. Embodiments may execute on the mobile device 101, and the same application or a separate profile or comparison engine may execute on the intermediate computer 101. Further embodiments are directed to systems configured or operable for location-based profile-to-profile matching of employers 14 and candidate employees 12. System embodiments may include a single mobile communication device 101 configured to implement method steps as discussed above, e.g., a mobile communication device 101 with the application 103 executing thereon, mobile communication devices 101, 104 of the employer 14 and the candidate 12 and/or agent 22, the intermediate computer 102 configured or operable to perform profile 16,18 comparisons, profile selections, management of location data 20,26, and to serve as an interface between an employer's device 104, the agent's device 101 and/or the candidate employee's mobile device 101. Further system embodiments may involve one or multiple mobile communication devices 101,104 and the intermediate computer 102.

In a single or multiple embodiments, in addition to receiving employer 16 and candidate profiles 18 (which can include job location and candidate experience or personality trait data), applications 103 executing in mobile communication devices 101 can be configured to determine a current location 20, e.g., Global Positioning System (GPS) location, and transmit that location data 20 to the intermediate computer 102. Location data 10,26 can include distance between mobile communication devices 101,104 and/or distance between the candidate's/agent's mobile device 101 and the employer 14 (e.g. employer individual, employer building, etc.).

In a single or multiple embodiments, part of the comparison or processing performed by the profile engine or intermediate computer 102 of the employment service 24 can be determining a current location 26 of the employer 14 and/or location 20 of the candidate employee 12, and filtering out matching results based on the distance between them, e.g., during match processing based on the location 20 of the mobile device 101 (e.g. candidate 12 or agent 22), an employer 14 identified as a potential match result is excluded due to the current employer location 26 being greater than a pre-determined distance from the current location 20, as determined by locations of their respective mobile communication devices 101, 104. As another example, during matching of an employer 14 with an employee 12, a candidate employee 12 identified as a potential match result is excluded due to the candidate employee 12 having a location 20 (of the mobile device 101 of the candidate of the agent 22 associated with the candidate profile 18) that is greater than a pre-determined distance from the location 26 of the employment location 26, e.g., as determined from location data 26 of employer 12 and mobile device 101.

The computer device 102 can be provided as a secure enterprise mobile services gateway/server in communication with the device 101,104 over an enterprise network 11 (e.g. Virtual Private Network (VPN) established over the network). Preferably, the communications network 11 comprises a wide area network such as the Internet, however the network 11 may also comprise one or more local area networks 11, one or more wide area networks, or a combination thereof. Further, the network 11 need not be a land-based network, but instead may comprise a wireless network and/or a hybrid of a land-based network and a wireless network for enhanced communications flexibility.

In terms of communications on the network 11, these communications can be between computer devices (e.g. device 101,104 and device 102) consisting of addressable network packages following a network communication protocol (e.g. TCPIP), such that the communications can include application data 32,34,38 communicated with the secure enterprise mobile services gateway/server (e.g. remote computer device 102). In some embodiments, the secure enterprise mobile services gateway server 102 can provide access to various enterprise network intranet services.

In general, application 103 software, also known as an application or an app, is computer software designed to help the device 101 user to perform specific tasks or activities via the user interface of their device 101. An application 103 can manipulate text, numbers, graphics, or a combination of these elements via the user interface of the device 101. Examples of application 103 software include enterprise hosted software (e.g. addresses the needs of organization processes and data flow, often in a large distributed environment), graphics software and media players. Applications 103 may be bundled with the computer and its system software, or may be published separately. Application 103 software is contrasted with system software and middleware (e.g. part of the device component and software system), which manage and integrate a computer's capabilities, but typically do not directly apply in the performance of tasks that benefit the user. The system software serves the application 103, which in turn serves the user.

### Example of Mobile Device 101

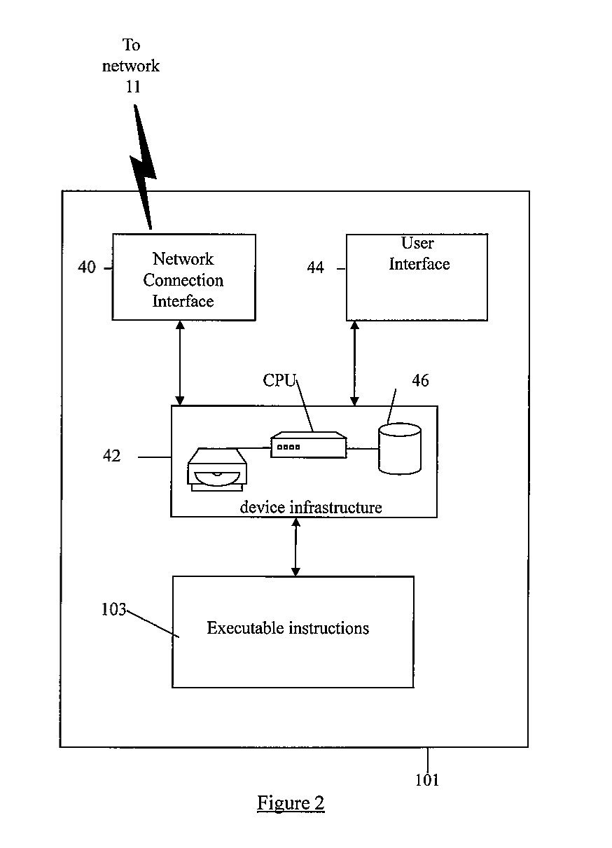

Referring to FIG. 2, a computing device 101 implementing functionality of the job discovery system 10 can include a network connection interface 40, such as a network interface card or a modem, coupled via connection to a device infrastructure 42. The connection interface 40 is connectable during operation of the devices to the network 11 (e.g. an intranet and/or an extranet such as the Internet), which enables networked devices to communicate with each other as appropriate. The network 11 can support the communication of the applications 103 provisioned.

Referring again to FIG. 2, the device 101 can also have the user interface 44, coupled to the device infrastructure 42, to interact with a user. The user interface 44 can include one or more user input devices such as but not limited to a QWERTY keyboard, a keypad, a stylus, a mouse, a microphone and the user input/output device such as an LCD screen display and/or a speaker. If the screen is touch sensitive, then the display can also be used as the user input device as controlled by the device infrastructure 42.

Referring again to FIG. 2, operation of the device 101 is facilitated by the device infrastructure 42. The device infrastructure 42 includes one or more computer processors CPU and can include an associated memory 46. The computer processor CPU facilitates performance of the device 101 configured for the intended task (e.g. of the respective module(s)) through operation of the network interface 40, the user interface 44 and other application programs/hardware 103 of the device 101 by executing task related instructions. These task related instructions can be provided by an operating system, and/or software applications located in the memory 46, and/or by operability that is configured into the electronic/digital circuitry of the processor(s) CPU designed to perform the specific task(s). Further, it is recognized that the device infrastructure 42 can include a computer readable storage medium coupled to the processor CPU for providing instructions to the processor CPU and/or to load/update the instructions (e.g. applications 103). The computer readable medium can include hardware and/or software such as, by way of example only, magnetic disks, magnetic tape, optically readable medium such as CD/DVD ROMS, and memory cards. In each case, the computer readable medium may take the form of a small disk, floppy diskette, cassette, hard disk drive, solid-state memory card, or RAM provided in the memory module. It should be noted that the above listed example computer readable mediums can be used either alone or in combination.

Further, it is recognized that the computing device 101 can include the executable applications comprising code or machine readable instructions for implementing predetermined functions/operations including those of an operating system and the modules, for example. The processor CPU as used herein is a configured device and/or set of machine-readable instructions for performing operations as described by example above, including those operations as performed by any or all of the modules. As used herein, the processor CPU may comprise any one or combination of, hardware, firmware, and/or software. The processor CPU acts upon information by manipulating, analyzing, modifying, converting or transmitting information for use by an executable procedure or an information device, and/or by routing the information with respect to an output device. The processor CPU may use or comprise the capabilities of a controller or microprocessor, for example. Accordingly, any of the functionality of the modules may be implemented in hardware, software or a combination of both. Accordingly, the use of a processor CPU as a device and/or as a set of machine-readable instructions is referred to generically as a processor/module for sake of simplicity.

Preferably, the communications network 11 comprises a wide area network such as the Internet, however the network 11 may also comprise one or more local area networks 11, one or more wide area networks, or a combination thereof. Further, the network 11 need not be a land-based network, but instead may comprise a wireless network and/or a hybrid of a land-based network and a wireless network for enhanced communications flexibility. The communications network 11 is used to facilitate network interaction between the devices 101,104 and the servers 102. In terms of communications on the network 11, these communications can be between the computer devices (e.g. device 101 and device 102) consisting of addressable network packages following a network communication protocol (e.g. TCPIP), such that the communications can include compliance characteristic data communicated using appropriate predefined encryption as used between the device infrastructure 42 and the secure enterprise mobile services gateway or server 102.

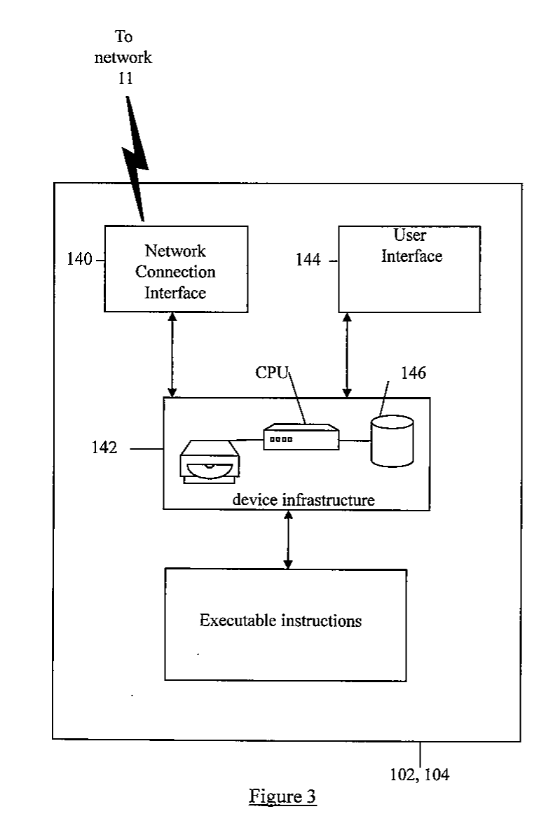

Referring to FIG. 3, the server/device 102,104 implementing the employment service 24 or implementing the employer's 14 computer system can be a computing device implementing functionality of the job discovery system 10 and include a network connection interface 140, such as a network interface card or a modem, coupled via connection to a device infrastructure 142. The connection interface 140 is connectable during operation of the devices to the network 11 (e.g. an intranet and/or an extranet such as the Internet), which enables networked devices to communicate with each other as appropriate. The network 11 can support the communication of the applications provisioned.

Referring again to FIG. 3, the device 102,104 can also have the user interface 144, coupled to the device infrastructure 142, to interact with a user. The user interface 144 can include one or more user input devices such as but not limited to a QWERTY keyboard, a keypad, a stylus, a mouse, a microphone and the user input/output device such as an LCD screen display and/or a speaker. If the screen is touch sensitive, then the display can also be used as the user input device as controlled by the device infrastructure 142.

Referring again to FIG. 3, operation of the device 102,104 is facilitated by the device infrastructure 142. The device infrastructure 142 includes one or more computer processors CPU and can include an associated memory 146 (e.g. storage 28 as per FIG. 1). The computer processor CPU facilitates performance of the device 102 configured for the intended task (e.g. of the respective module(s)) through operation of the network interface 140, the user interface 144 and other application programs/hardware 24 of the device 102 by executing task related instructions. These task related instructions can be provided by an operating system, and/or software applications located in the memory 146, and/or by operability that is configured into the electronic/digital circuitry of the processor(s) CPU designed to perform the specific task(s). Further, it is recognized that the device infrastructure 142 can include a computer readable storage medium coupled to the processor CPU for providing instructions to the processor CPU and/or to load/update the instructions (e.g. applications). The computer readable medium can include hardware and/or software such as, by way of example only, magnetic disks, magnetic tape, optically readable medium such as CD/DVD ROMS, and memory cards. In each case, the computer readable medium may take the form of a small disk, floppy diskette, cassette, hard disk drive, solid-state memory card, or RAM provided in the memory module. It should be noted that the above listed example computer readable mediums can be used either alone or in combination.

Further, it is recognized that the computing device 102,104 can include the executable applications comprising code or machine readable instructions for implementing predetermined functions/operations including those of an operating system and the modules, for example. The processor CPU as used herein is a configured device and/or set of machine-readable instructions for performing operations as described by example above, including those operations as performed by any or all of the modules. As used herein, the processor CPU may comprise any one or combination of, hardware, firmware, and/or software. The processor CPU acts upon information by manipulating, analyzing, modifying, converting or transmitting information for use by an executable procedure or an information device, and/or by routing the information with respect to an output device. The processor CPU may use or comprise the capabilities of a controller or microprocessor, for example. Accordingly, any of the functionality of the modules may be implemented in hardware, software or a combination of both. Accordingly, the use of a processor CPU as a device and/or as a set of machine-readable instructions is referred to generically as a processor/module for sake of simplicity.

We claim:

1. A computer implemented employment discovery system for identifying a potential employment position of an employer for an employment candidate, the system comprising:
a computer processor configured for executing of a set of instructions stored in a memory for:
storing candidate profile information and a candidate contact address of a candidate mobile device associated with the employment candidate;
storing agent profile information for a candidate agent associated with the employment candidate including an agent contact address of an agent mobile device associated with the candidate agent;
accessing employment profile information of the potential employment position including geographical information of the employer;
receiving a geographical location of the agent mobile device and generating a geographical match of the geographical location with the geographical information by comparing the geographical location with the geographical information;
generating a profile match of the candidate profile information with the employment profile information by comparing the candidate profile information with the employment profile information;
based on the geographical match and the profile match, generating a match message including details of the potential employment position and the geographical information of the employer; and
sending the match message to the agent contact address over a communications network to the agent mobile device.

2. The employment discovery system of claim 1 further comprising:
receiving confirmation of an action taken by the agent in response to receiving the match message.

3. The employment discovery system of claim 2, wherein the confirmation of an action taken is a contact message including details of a network communication between the agent mobile device and the candidate mobile device.

4. The employment discovery system of claim 1, wherein the profile match is based on matching a threshold amount of candidate profile parameters of the candidate profile information with employment profile parameters of the employment profile information.

5. The employment discovery system of claim 1, wherein the geographical match is based on matching a location threshold between the geographical location and the geographical information.

6. The employment discovery system of claim 1 further comprising: sending image content of the candidate to the employer based on at least one of the profile match or the geographical match.

7. The employment discovery system of claim 6 further comprising:
dynamically generating the image content on the candidate mobile device or selecting the image content stored in the candidate profile.

8. The employment discovery system of claim 1 further comprising:
associating the agent profile information with the candidate profile information, such that the geographical information is associated with the candidate profile information.

9. The employment discovery system of claim 8 further comprising:
receiving a status request from the agent mobile device; and sending details of the status information over the communications network to the agent mobile device.

10. The employment discovery system of claim 1, wherein the potential employment position is an employment type selected from the group consisting of: regular activity performed in exchange for payment; and a volunteer activity.

11. A computer implemented employment discovery system for identifying a potential employment position of an employer for an employment candidate, the system comprising:
a computer processor configured for executing of a set of instructions stored in a memory for:
storing candidate profile information of a candidate profile and a contact address of a mobile device associated with the candidate profile;
accessing employment profile information of the potential employment position including geographical information of the employer;
receiving a geographical location of the mobile device and generating a geographical match of the geographical location with the geographical information by comparing the geographical location with the geographical information;
generating a profile match of the candidate profile information with the employment profile information by comparing the candidate profile information with the employment profile information;
based on the geographical match and the profile match, generating a match message including details of the potential employment position and the geographical information of the employer; and
sending the match message to the contact address over a communications network to the mobile device.

12. The employment discovery system of claim 11 further comprising:
receiving confirmation of an action taken by the candidate in response to receiving the match message.

13. The employment discovery system of claim 12, wherein the confirmation of an action taken is a contact message including details of a network communication between an agent mobile device and the candidate mobile device, the agent associated with the employment candidate including an agent contact address of the agent mobile device associated with the agent.

14. The employment discovery system of claim 13, wherein the contact message details include candidate suitability statements made by the employer about the employment candidate with respect to the potential employment position.

15. The employment discovery system of claim 11 further comprising:
sending image content of the candidate to the employer based on at least one of the profile match or the geographical match.

16. The employment discovery system of claim 15 further comprising:
dynamically generating the image content on the candidate mobile device or selecting the image content stored in the candidate profile.

17. The employment discovery system of claim 11 further comprising:
receiving a status request from the agent mobile device; and sending details of the status information over the communications network to the agent mobile device.

18. The employment discovery system of claim 11 further comprising:
storing agent profile information for an agent including a contact address of an agent mobile device associated with the agent;
receiving confirmation of agreement of the agent to be agent for the employment candidate;
associating the agent profile information with the candidate profile information including the contact address as an agent candidate pairing; and
sending an agent confirmation message to the candidate contact address over the communications network to the candidate mobile device confirming the agent as at least one agent representing the employment candidate.

19. The employment discovery system of claim 18 further comprising:
receiving confirmation of agreement of a second agent to be agent for the employment candidate;
associating second agent profile information of the second agent with the candidate profile information including the contact address; and
sending a further agent confirmation message to the candidate contact address over the communications network to the candidate mobile device confirming the second agent as another agent representing the employment candidate.

20. The employment discovery system of claim 15, wherein the image content is either selected or generated based on a request or question sent by the employer to the candidate.
